(19) United States
(12) Patent Application Publication
(10) Pub. No.: US 2014/0070768 A1
(43) Pub. Date: Mar. 13, 2014

(54) ACTIVE VEHICLE RECHARGE PROTECTION DEVICE

(71) Applicant: Fu-Chieh Chen, Taichung (TW)

(72) Inventor: Fu-Chieh Chen, Taichung (TW)

(21) Appl. No.: 13/802,667

(22) Filed: Mar. 13, 2013

(30) Foreign Application Priority Data
Sep. 7, 2012 (TW) 101217420

(51) Int. Cl. H02J 7/00; B60L 11/18

(52) U.S. Cl. CPC H02J 7/0029; B60L 11/1809
USPC 320/109

(57) ABSTRACT

active vehicle recharge protection device includes a detection unit, a control unit and an annunciator. The detection unit is connected electrically with a recharge power source and is a voltage detection circuit used to detect the output voltage of the recharge power source.

The control unit is connected electrically with the detection unit and a battery. In addition, the control unit is a microcontroller used to control the supply of electric energy to the battery based upon the voltage detected by the detection unit. The annunciator is connected electrically with the control unit. Overvoltage protection and undervoltage protection are executed to the battery by the detection unit and the control unit, preventing the battery from being charged at an abnormal voltage to affect the accumulation capacity and the lifetime of use of the battery.

### BACKGROUND OF THE INVENTION

a) Field of the Invention

The present invention relates to a battery which can be charged and discharged repeatedly, and more particularly to an active vehicle recharge protection device, wherein a detection unit determines a charging voltage as a basis for a control unit to charge the battery, thereby protecting the battery.

b) Description of the Prior Art

The car-use battery is a secondary battery that can be charged and discharged repeatedly. This battery supplies electric energy to an ignition system of an engine and car lamps that consume electricity. In addition, the battery supplies electric energy to a starter motor if a user needs to start the car engine from an extinction state. After starting operation, the engine will drive a generator to operate. The generator produces electric energy to recharge the battery, thereby supplementing electric energy accumulated in the battery. On the other hand, the car-use battery can be also charged by an external power source. Therefore, the on-board generator and the external power source that recharge the battery are called recharge power source hereinafter.

The recharge power source is provided with a rectifier to convert AC (Alternating Current) power into DC (Direct Current) power that outputs to the battery. However, when the recharge power source is unable to operate normally that the voltage at which the battery supplies electric energy is too high or too low, the accumulation capacity of the battery will be affected disadvantageously, which results in that the lifetime of use of the battery can be reduced. This abnormal voltage at which the battery is charged can damage the battery or cause the battery to explode if the situation is severe.

Accordingly, by the constant research of the present inventor, the present invention with creativity and business value is created.

### SUMMARY OF THE INVENTION

The primary object of the present invention is to provide an active vehicle recharge protection device, wherein the determination of the voltage is used as a basis for controlling the supply of electric energy to the car-use battery, thereby protecting the battery.

The present invention relates to an active vehicle recharge protection device and comprising a detection unit, a control unit and an annunciator, wherein the detection unit is connected electrically with a recharge power source and is a voltage detection circuit used to detect the output voltage of the recharge power source, the control unit is connected electrically with the detection unit and a battery and is a microcontroller used to control the supply of electric energy to the battery based upon the voltage detected by the detection unit, and the annunciator is connected electrically with the control unit.

If the output voltage of the recharge power source is higher than a high potential voltage 14.5V for 10 seconds continuously, the control unit activates a forced power off operation and the annunciator sends out a warning signal to inform a user, thereby executing overvoltage protection.

If the output voltage of the recharge power source is lower than a low potential voltage 12.5V for 10 seconds continuously, the control unit activates a forced power off and the annunciator sends out a warning signal to inform a user, thereby executing undervoltage protection.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a block diagram of an embodiment of the present invention; and

FIG. 2 shows a flow diagram of an operation of installing the embodiment of the present invention at a vehicle.

### DETAILED DESCRIPTION OF THE PREFERRED EMBODIMENTS

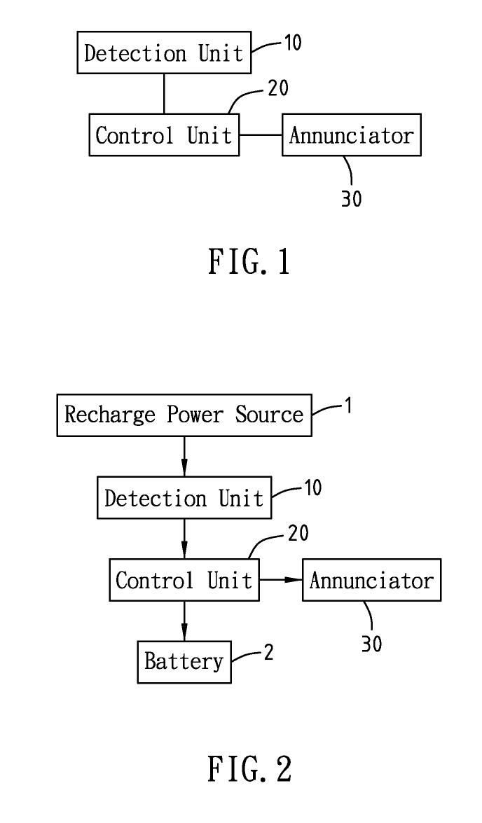

Referring to FIG. 1 and FIG. 2, an embodiment of an active vehicle recharge protection device, according to the present invention, comprises a detection unit 10, a control unit 20 and an annunciator 30. The detection unit 10 is connected electrically with an output end of a rectifier of a recharge power source 1. In addition, the detection unit 10 is a voltage detection circuit that is used to detect the voltage at which the recharge power source 1 outputs electric energy. The control unit 20 is connected electrically with the detection unit 10 and a battery 2. Furthermore, the control unit 20 is a microcontroller that is used to control the supply of electric energy to the battery 2 based upon the voltage detected by the detection unit 10, thereby protecting the battery 2. The annunciator 30 is connected electrically with the control unit 20 and is used to send out a warning signal in sound or light to inform a user when the battery 2 is charged abnormally.

The detection unit 10 detects the output voltage of the recharge power source 1 as a basis for determining whether to transmit electric energy to the battery 2. The control unit 20 then controls the supply of electric energy to the battery 2, thereby executing overvoltage protection or undervoltage protection to the battery 2. The flow of operation of the present invention is disclosed below:

1. Overvoltage protection
First of all, the detection unit 10 detects the output voltage of the recharge power source 1. When the output voltage of the recharge power source 1 is lower than a high potential voltage, the next step is executed. On the contrary, if the output voltage of the recharge power source 1 is higher than the high potential voltage for 10 seconds continuously, the control unit 20 will activate a forced power off operation and the battery 2 will not be able to acquire electric energy from the recharge power source 1, thereby executing the overvoltage protection to the battery 2. In addition, the control unit 20 will control the annunciator 30 to send out a warning signal to inform the user, allowing the user to be aware of that battery 2 cannot be recharged and to take a response in time, such as cutting off a car switch and then restarting the car or inspecting the recharge power source 1, by the warning signal sent out from the annunciator 30. After the control unit 20 has activated the power off operation due to that the output voltage of the recharge power source 1 is too high, the detection unit 10 will continue to detect the output voltage of the recharge power source 1. When the output voltage of the recharge power source 1 returns to be less than the high potential voltage for 10 seconds continuously, the next step will be executed and the annunciator 30 will stop sending out the warning signal. The abovementioned high potential voltage is 14.5V.

2. Undervoltage protection
When the output voltage of the recharge power source 1 is lower than the high potential voltage, the output voltage of the recharge power source 1 is determined whether it is lower than a low potential voltage. If the output voltage of the recharge power source 1 is higher than the low potential voltage, electric energy is supplied to the battery 2. On the contrary, if the output voltage of the recharge power source 1 is lower than the low potential voltage for 10 seconds continuously, the control unit 20 will activate the forced power off operation and the battery 2 will not be able to acquire electric energy from the recharge power source 1. In addition, the control unit 20 will control the annunciator 30 to send out the warning signal to inform the user, thereby executing the undervoltage protection to the battery 2. The user is able to be aware of that battery 2 cannot be recharged and to take a response in time, such as cutting off a car switch and then restarting the car or inspecting the recharge power source 1, by the warning signal sent out from the annunciator 30. After the control unit 20 has activated the power off operation due to that the output voltage of the recharge power source 1 is too low, the detection unit 10 will continue to detect the output voltage of the recharge power source 1. When the output voltage of the recharge power source 1 returns to be higher than the low potential voltage for 10 seconds continuously, electric energy can be supplied to the battery 2 again and the annunciator 30 will stop sending out the warning signal. The abovementioned low potential voltage is 12.5V.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An active vehicle recharge protection device comprising a detection unit, a control unit and an annunciator, wherein the detection unit is connected electrically with a recharge power source and is a voltage detection circuit used to detect the output voltage of the recharge power source, the control unit is connected electrically with the detection unit and a battery and is a microcontroller used to control the supply of electric energy to the battery based upon the voltage detected by the detection unit, and the annunciator is connected electrically with the control unit.

2. The active vehicle recharge protection device according to claim 1, wherein if the output voltage of the recharge power source is higher than a high potential voltage for 10 seconds continuously, the control unit activates a forced power off operation and the annunciator sends out a warning signal to inform a user, thereby executing overvoltage protection.

3. The active vehicle recharge protection device according to claim 2, wherein the high potential voltage is 14.5V.

4. The active vehicle recharge protection device according to claim 1, wherein if the output voltage of the recharge power source is lower than a low potential voltage for 10 seconds continuously, the control unit activates a forced power off and the annunciator sends out a warning signal to inform a user, thereby executing undervoltage protection.

5. The active vehicle recharge protection device according to claim 4, wherein the low potential voltage is 12.5V.
